(19) United States
(12) Patent Application Publication
(10) Pub. No.: US 2020/0017665 A1
(43) Pub. Date: Jan. 16, 2020

(54) GERM-REPELLENT MATERIAL

(71) Applicant: Nano and Advanced Materials Institute Limited, Hong Kong (HK)

(72) Inventors: Michael Kwun Fung LO, Hong Kong (HK); Sheung Yi LI, Hong Kong (HK); Chris You WU, Hong Kong (HK); Chen CHEN, Hong Kong (HK); Connie Sau Kuen KWOK, Hong Kong (HK)

(21) Appl. No.: 16/032,049

(22) Filed: Jul. 10, 2018

(51) Int. Cl. C08L 23/06; C08K 5/098; C08K 5/103; C08K 5/11; C08K 5/00

(52) U.S. Cl. CPC C08L 23/06; C08K 5/098; C08K 5/103; C08K 5/11; C08L 2203/02; C08L 2205/24; C08L 2207/062; C08L 2207/066; C08K 5/0058

(57) ABSTRACT

The present invention provides a germ-repellent polymer composition comprising: a base polymer selected from one or more of polyethylene, polypropylene, poly(lactic acid), polyhydroxylalkanoates, or copolymers or mixtures thereof; a germ-repelling modifier selected from a glycerol ester; and a nucleating agent.

### FIELD OF INVENTION

The present invention provides a germ-repellent material and an article comprising thereof. More specifically, the present material is glycerol-based and non-PEG-based.

### BACKGROUND

Lau et al. in US patent application under publication numbers US2017/129139A1 and US2017/135344A1 disclosed at least two different methods of preparing antifouling materials for use with base plastics, which are melt extruding a masterbatch containing an antifouling agent and a base plastic or dry blending of the base plastic with the antifouling agent. Either way can result in an antifouling plastic. However, the antifouling agents used in Lau et al. are synthetic materials that are mostly originated from oil by-products.

The same applicant/assignee as in Lau et al. has recently filed a PCT application under the application number PCT/CN2018/028239 on Apr. 9, 2018. PEG-based antifouling agents were mainly used in that PCT application, and base resins such as low-density polyethylene polymer, polypropylene, and polyolefin elastomer, or polyvinyl chloride polymer, and their copolymers, were not used. Again, the antifouling agents used in that PCT application are synthetic material mostly originated from potentially harmful sources.

There is a need for a bio- and eco-friendly materials to be used as antifouling agents to impart germ repellence into a base plastic which is also suitable for food processing and a method for improving the germ repellent structure of the base plastic. Some materials such as stearic acid and cholic acid are biofriendly but they do not produce sufficient germ-repelling actions; some stearates such as sucrose stearates and glycerol additives will turn brown after compounding through melt or dry extrusion which is not satisfactory for being use with plastics in food processing industry.

### SUMMARY OF INVENTION

Accordingly, the present invention provides a germ-repellent polymer composition comprising a base polymer selected from one or more of polyethylene, polypropylene, poly(lactic acid), polyhydroxylalkanoates, or copolymers or mixtures thereof; a germ-repelling modifier selected from a glycerol ester; and a nucleating agent.

In one embodiment, the polyethylene is high-density or low-density polyethylene. Said polyethylene is formed by monomer(s) derived from sugar or other natural sources.

In another embodiment, the glycerol ester comprises monoglycerides, diglycerides and polyglycerides of fatty acids. The fatty acids are preferably derived from food products such as beans or animal fats. The fatty acids can be saturated or unsaturated fatty acids with aliphatic tails of 8 to 22 carbons. The glycerol ester can include equal to or less than 6 glycerol units.

In other embodiment, the glycerol ester is selected from stearates of glycerol or polyglycerol. For example, said glycerol ester is selected from stearates of monoglycerides and diglycerides (MDG) or glyceryl monostearate (GMS). The germ-repelling modifier, or the glycerol ester, comprises 0.1 to 10 weight percent of the polymer composition.

In yet another embodiment, the nucleating agent is calcium ion-based nucleating agent. For example, the calcium ion-based nucleating agent has the following formula:

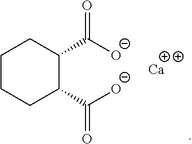 [SMILES: O=C([O-])[C@H]1CCCC[C@H]1C(=O)[O-] ; [Ca+2]]

The nucleating agent comprises 0.1 to 1.0 phr of the polymer composition.

Through the addition of a nucleating agent, efficient lamellae nucleation is induced. By producing sufficient lamellae spherulite formation is suppressed.

The germ-repellent polymer composition of the present invention can be prepared by a method comprising:
a. melt-blending of a mixture of the base polymer, germ-repellent modifier and nucleating agent; or
b. melt-blending of a functional masterbatch comprising base polymer, germ-repellent modifier and nucleating agent with the base polymer.

In one embodiment, the weight ratio of germ-repellent modifier used in step (a) is from 0.1 to 10 wt. %.

In another embodiment, the weight ratio of functional masterbatch used in step (b) is from 2 to 40 wt. %.

In other embodiment, the weight ratio of germ-repellent modifier in the functional masterbatch used in step (b) is from 2 to 60 wt. %

This Summary is intended to provide an overview of the present invention and is not intended to provide an exclusive or exhaustive explanation.

### BRIEF DESCRIPTION OF THE DRAWINGS

Embodiments of the present invention are described in more detail hereinafter with reference to the drawings, in which:

FIG. 1 shows an ATR-FTIR spectrum of G810S/GMS with G810S control;

FIG. 2 shows an ATR-FTIR spectrum of SHA7260/GMS5 with SHA7260 control;

FIG. 3 shows a schematic illustration of lamella (left) and spherulites (right) formation in polymer during cooling;

FIG. 4 shows an ATR-FTIR spectra of SHA7260 (solid line) and GMS2N (dotted line);

FIG. 5A shows an ATR-FTIR spectrum of GMS5N with SHA7260 control;

FIG. 5B shows an ATR-FTIR spectrum of M25 with SHA7260 control;

FIG. 6A shows a cooling curve of SHA7260;

FIG. 6B shows a second heating curve of SHA7260;

FIG. 7A shows a cooling curve of SHA7260/GMS5;

FIG. 7B shows a second heating curve of SHA7260/GMS5;

FIG. 8A shows a cooling curve of M25;

FIG. 8B shows a second heating curve of M25;

FIG. 9A shows a cooling curve of GMS5N;

FIG. 9B shows a second heating curve of GMS5N;

FIG. 10 shows cytotoxicity of SHA7260/GMS materials.

### DETAILED DESCRIPTION OF INVENTION

The present invention is not to be limited in scope by any of the following descriptions. The following examples or embodiments are presented for exemplification only.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Definitions

The singular forms “a,”, “an” and “the” can include plural referents unless the context clearly dictates otherwise.

The term “about” can allow for a degree of variability in a value or range, for example, within 10%, or within 5% of a stated value or of a stated limit of a range.

The term “independently selected from” refers to referenced groups being the same, different, or a mixture thereof, unless the context clearly indicates otherwise. Thus, under this definition, the phrase “X1, X2, and X3 are independently selected from noble gases” would include the scenario where, for example, X1, X2, and X3 are all the same, where X1, X2, and X3 are all different, where X1 and X2 are the same but X3 is different, and other analogous permutations.

The term “phr” defines as the per hundred rubber, which refers to the compound ingredients given as parts per 100 unit mass of the rubber polymer, which is prevalently referred as the polymeric base resin.

Description

The following examples accompanied with drawings will illustrate the present invention in more detail.

### EXAMPLES

The embodiments of the present invention can be better understood by reference to the following examples which are offered by way of illustration. The present invention is not limited to the examples given herein.

Selection of Base Plastic Materials Based on Germ Repellence Performance Test:

Two different models of bio-derived polyethylene, Braskem SHA7260 HDPE and Braskem SBF0323HC LDPE, were used as candidates of base resin in the present invention. The expression “bio-derived” relates to polyethylenes made from ingredients such as ethanol which becomes ethylene after a dehydration process. The ethanol may be sourced from sugars such as those from sugar cane, sugar beet, and wheat.

The germ repelling experiments were conducted according to the following general procedures, so as other germ repelling experiments in the present invention. Stock inoculum of E. coli and S. aureus were first prepared with OD about 0.6-0.7 and 1.2-1.5 respectively. The stocks were then diluted by 10 times for E. coli and 100 times for S. aureus. 1 mL of diluted inoculum was added on 3 cm×3 cm sample surface and then incubated for 1 day at 37° C. After incubation, the inoculum was removed from the surface of sample. The sample was then rinsed by 5 mL of 0.9 wt % saline. The remaining bacteria on the sample surface were collected by cotton wool swab. The number of bacteria colonies remaining was evaluated to investigate the germ repelling performance of sample against E. coli and S. aureus.

The germ repelling performance against E. coli and S. aureus of both polyethylene (PE) were examined. Detail results were listed in the following table. The result of the experiment revealed that SHA7260 had a poor germ repelling performance against both E. coli and S. aureus, while SBF0323HC only had a poor germ repelling performance against S. aureus. Therefore, SHA7260 was chosen as the base resin in the present invention. It should be noted that SHA7260 is suitable for injection moulding.

TABLE 1
Germ repelling performance of SHA7260 (HDPE) and SBF0323HC
(LDPE) against E. coli and S. aureus

| | SHA7260 | SBF0323HC |
|---|---|---|
| E. coli (c.f.u. per mL) | 1.78 × 10⁴ | 0 |
| S. aureus (c.f.u. per mL) | 1.58 × 10⁵ | 6.22 × 10⁴ |

The quality of received SHA7260 was examined through MFI measurement. The MFI value of received SHA7260 measured in-house was about 18 g/10 min, which closely matched to that provide on the data sheet (20 g/10 min). In addition, other models of polyethylene, polypropylene, and polylactic acid could be modified to impart the germ-repellent functionality.

### Example 1

Selection of natural compounds in the pre-screening phase was inspired by a few natural substances: beeswax, soap and bile as could be used with food products. Beeswax was chosen for the screening because it was one of the natural preservatives with low toxicity. The major chemical components of beeswax are monoesters and fatty alcohols.

According to previous experiments by the common inventors of the present invention, the addition of wetting agents or emulsifying agents may improve the germ repelling performance of the resin, and hence two common natural detergents, soap and bile were chosen for the investigation.

The compounds representing natural substances were listed as followings with their addition amount in base resin G810S, which is a LDPE material for only the initial screening purposes.

TABLE 2
Pre-screening selections for germ repelling
resin based on natural compounds.

| Natural substance | Compound | Additive amount |
|---|---|---|
| Beeswax | Beeswax white | 5 phr |
| Soap | Stearic acid | 5 phr |
| Bile | Cholic acid | 2 phr |

Since cholic acid was much more expensive than beeswax white and stearic acid, its amount added in resin was reduced to reflect the price factor. The three selected compounds were added into G810S granules and mixed well to obtain the dried blends. The dried blends were then extruded using a twin-screw extruder. The temperature profile of extruder was listed in the following table. This profile was used for other extrusion for polyethylene (PE) except masterbatch formulation. The extruded resins were pelletized and then dried in oven at 50° C.

TABLE 3
Temperature profile for extrusion of LDPE and HDPE
samples except masterbatch.

| | Zone | | | | | | Die |
|---|---|---|---|---|---|---|---|
| | 1 | Zone 2 | Zone 3 | Zone 4 | Zone 5 | Zone 6 | head |
| Temp/° C. | 90 | 130 | 150 | 160 | 170 | 180 | 180 |

The details of germ repelling experiment were listed in the following table. The germ repelling performance was evaluated by comparing the percentage change of colony counted comparing to base resin. The pre-screening result has shown that beeswax and stearic acid had a negative effect on germ repelling performance against E. coli while cholic acid had an obvious but not satisfactory performance. All three formulations have shown no improvement on the germ repelling performance against S. aureus.

TABLE 4
germ repelling performance of pre-screening formulations
against E. coli and S. aureus

| | E. coli | S. aureus |
|---|---|---|
| Formulation | performance | performance |
| Beeswax white - 5 phr | +330% | +9% |
| Stearic acid - 5 phr | +1833% | +4% |
| Cholic acid - 2 phr | −52% | 0% |

### Example 2

From observation during extrusion, formulation with cholic acid had the best wettability. Correlating this observation and the pre-screening result, compounds with better hydrophilicity while with similar chemical structure to fatty acid or monoester were investigated. One of the candidates was food additives such as E471, mono- and diglycerides (MDG). E471 serves as a common emulsifier in many food products such as whipped cream. The structure of E471 resembles one or two fatty acids bonded on a glycerol molecule through ester linkage, which has a much higher hydrophilicity and wetting ability comparing to the corresponding fatty acid.

However, E471 is a mixture of many different compounds because it is mainly produced from glycerolysis of vegetable oil or animal fats, which may lead to an inconsistent germ repelling performance. One of the components in E471, which is commercially available in high purity was selected. This compound was glycerol monostearate (GMS) in molecular distilled grade. This compound is considered to be a ‘Generally Recognized as Safe’ (GRAS) ingredient according to the FDA, and therefore it should be guaranteed as a safe additive in resins for food contact usage.

Two formulations were prepared using GMS and MDG as additives in the G810S resin. Both GMS and MDG were received from GuangZhou Gardlo Biochemical Technology Co. Ltd. GMS and MDG were first mixed well in G810S to give a dried blend. The followings listed the detail of formulations. The results showed an excellent germ repelling performance after the addition of GMS and MDG in G810S.

TABLE 5
Formulations for screening test using G810S as base resin.

| Formulation | Base resin | Additive | Additive amount |
|---|---|---|---|
| G810S/GMS5 | G810S | GMS | 5 phr |
| G810S/MDG5 | | MDG | 5 phr |

TABLE 6
Germ repelling performance of all screening formulations against
E. coli and S. aureus relative to the virgin SHA7260 control

| Formulation | E. coli | S. aureus |
|---|---|---|
| G810S/GMS5 | −91% | −98% |
| G810S/MDG5 | −79% | −96% |

### Example 3

GMS was therefore chosen to improve our target polymer, SHA7260. GMS was first mixed with SHA7260 to give a dried blend for extrusion. The following lists the details of the formulation. However, the results have shown that GMS had a negative effect on the germ-repelling performance against E. coli while fair performance against S. aureus when the base resin was changed from G810S to SHA7260 (Table 7).

TABLE 7
Formulations for screening test using SHA7260 as base
resin and the germ repelling performance of all screening
formulations against E. coli and S. aureus relative
to the virgin control of Bio-HDPE SHA7260

| | Base | | Additive | | |
|---|---|---|---|---|---|
| Formulation | resin | Additive | amount | E. coli | S. aureus |
| SHA7260/ | SHA7260 | GMS | 5 phr | +590% | −46% |
| GMS5 | | | | | |

Inspection of Surface Chemistry Through ATR-FTIR Analysis

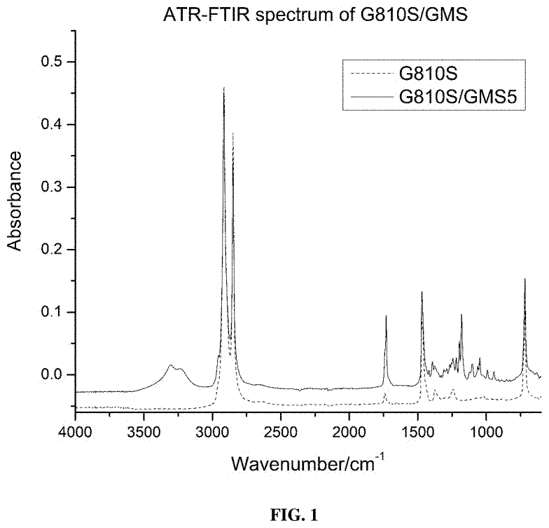

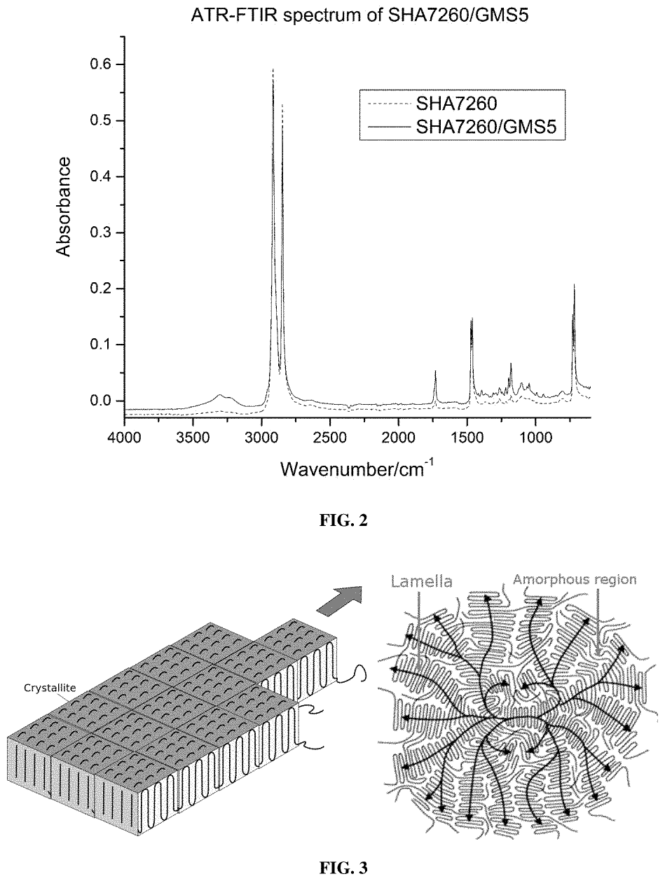

The difference between the two formulations was examined through their surface chemistry. ATR-FTIR spectroscopy was used to evaluate the hydroxyl content on the surface of the resin. According to previous experiments by the common inventors of the present invention, higher hydroxyl content reflects better hydrophilicity and therefore better wettability on the resin surface. The corresponding IR band of hydroxyl bond was located at about 3300 cm⁻¹. A larger band observed at this region suggested higher hydroxyl content on resin surface. The spectra in FIGS. 1 and 2 have shown that the hydroxyl content on G810S/GMS5 was higher than SHA7260/GMS5, which may explain the G810S/GMS5 better germ repelling performance.

One of the biggest differences between G810S and SHA7260 is their degree of crystallinity. G810S, a LDPE, has lower degree of crystallinity comparing to SHA7260 which is a HDPE. Lamellae were formed in the early stage of crystallization, and then further assembled into spherulites with amorphous region trapped between lamellae crystals, an illustrative example is shown in FIG. 3. It is proposed that GMS was trapped between these spherulites leading to lower hydroxyl content on the resin surface.

### Example 4

To resolve the crystallization of PE chains in SHA7260 and hence improving its germ-repelling action, the following approaches were taken: (1) adding LDPE into the resin to disturb the crystallization of HDPE; and (2) inducing efficient lamellae nucleation to suppress the formation of spherulites.

TABLE 8
Optimized formulations inspired by different approaches.

| | | | | Additives | |
|---|---|---|---|---|---|
| | Formulation | Base resin | Additives | amount | |
| Approach (1) | G810S/GMS33 | G810S | GMS | 33 | phr |
| | M25 | SHA7260 | G810S/GMS33 | 25 | phr |
| Approach (2) | GMS5N | | GMS | 5 | phr |
| | | | HPN-20E | 0.5 | phr |

Several formulations were designed to test the two approaches. For the first approach, a masterbatch of GMS using G810S as base resin was first prepared named as G810S/GMS33, equivalent to 25 wt % GMS in LDPE. Temperature profile for masterbatch extrusion was listed below, which was 10° C. less than the normal extrusion for PE.

TABLE 9
Temperature profile for extrusion of masterbatch.

| | Zone | | | | | | Die |
|---|---|---|---|---|---|---|---|
| | 1 | Zone 2 | Zone 3 | Zone 4 | Zone 5 | Zone 6 | head |
| Temp/° C. | 80 | 120 | 140 | 150 | 160 | 170 | 170 |

Preparation of masterbatch with higher GMS loading (50 phr) has been attempted but the extrudate was too soft for pelletizing in air. The masterbatch was then extruded with SHA7260 to give formulation M25, in which GMS content was similar to SHA7260/GMS5. The shortcomings of this approach were the involvement of two-pass extrusions and a high petroleum-derived chemical content in final formulation. On the other hand, it will be easily to tune down the GMS content through reducing masterbatch content, skipping the mixing of dried blend.

For the approach incorporating only the nucleator, HPN-20E received from Milliken & Company was used to trigger fast lamellae nucleation in order to suppress the formation of spherulites. HPN-20E and GMS were both mixed into SHA7260 to give a dried blend for direct extrusion to give formulation GMS5N. Since this formulation only passed through extruder once, fine-tuning of additives content would require starting over from mixing the dried blend again.

(A) Germ-Repelling Performance of Optimized Formulations:

Upon adding the nucleator, Bio-HDPE based formulations have shown good or excellent germ repelling performance against E. coli and S. aureus in polyethylene.

TABLE 10
Germ repelling performance of optimized formulation
against E. coli and S. aureus.

| | E. coli | S. aureus |
|---|---|---|
| Formulation | performance | performance |
| G810s/5 phr GMS | −96% | −86% |
| GMS1N SHA7260/1 phr | +18% | −94% |
| GMS/0.1 phr nucleator | | |
| GMS2N SHA7260/2 phr | −68% | −90% |
| GMS/0.2 phr nucleator | | |
| GMS5N SHA7260/5 phr | −88% | −89% |
| GMS/0.5 phr nucleator | | |

Since M25 might have a high content of petroleum-derived component due to the use of masterbatch based on LDPE G810S, a possible modification on this formulation could be changing the base resin G810S to another LDPE from Braskem Green PE Series, which requires more screening of base resin materials. The following sections will therefore focus on the analysis of SHA7260-based formulations since those are the closest match to the resin requirements in the present invention with greater than 90% of material derived from natural sources (SHA7260 contains greater than 94% of material derived from natural sources per manufacturer's technical specification).

(B) Correlation Between Performance and Characterization:

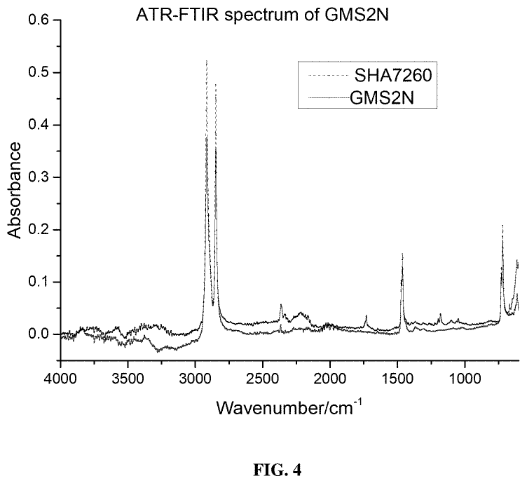

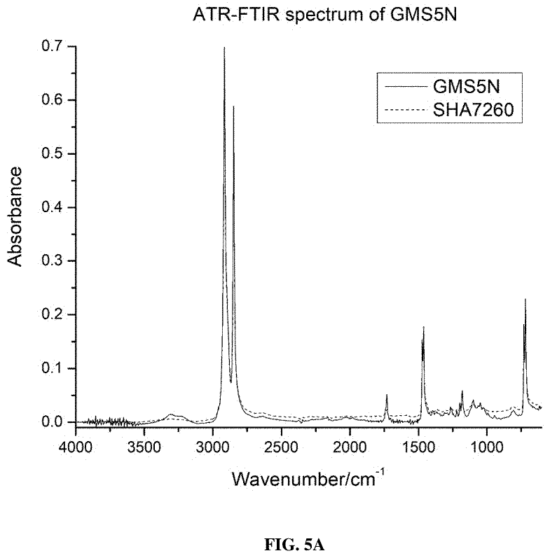

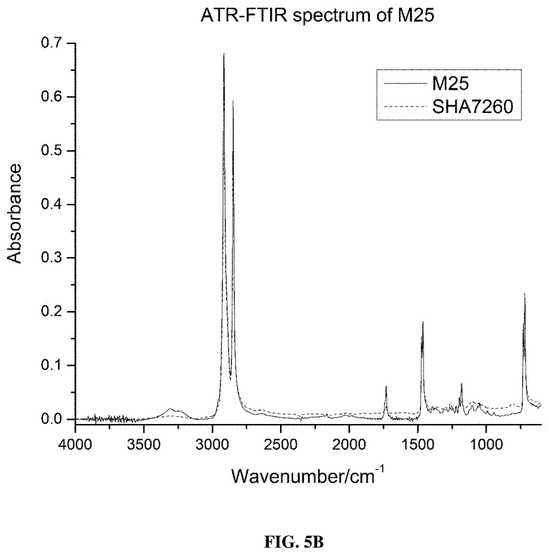

ATR-FTIR analysis of GMS2N (FIG. 4), GMS5N (FIG. 5A) and M25 (FIG. 5B) has shown no significant difference from SHA7260/GMS5. The penetration depth of ATR-FTIR spectrometer may be too high such that fine chemical features on surface were masked by resin underneath. The skin depth is in the order of 1 to 10 micrometers. Still the ester and hydroxy groups of the GMS's could be readily identified, which are indicative of their physical presence on the surface and/or in the bulk of the polymer matrix.

(C) Thermal Analysis:

Since it is proposed that the performance was affected by crystallization behaviours of resin, DSC studies were carried out to observe if there were any differences between formulations and their base resin. The DSC experiments were conducted under nitrogen with ramping rate of 10° C./min. Heating cycle of 1.5 was done, in which thermal history of resin was removed by the first heating cycle. Only the cooling curve and the second heating curve will be used for analysis of the crystallization of resins.

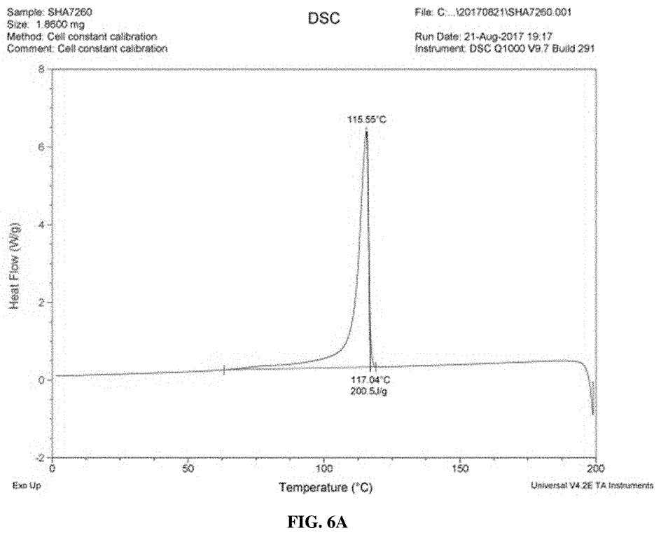

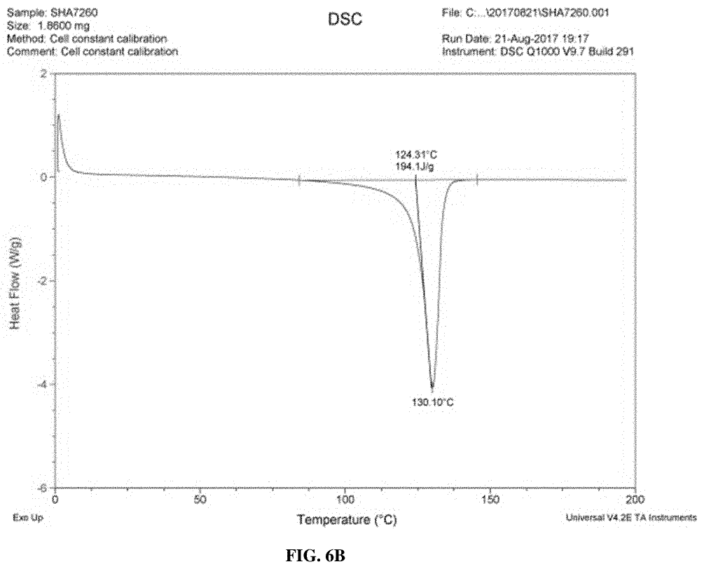

In FIGS. 6A and 6B, the cooling curve and heating curve of base resin SHA7260 have shown a typical HDPE behaviour. The melting point of SHA7260 was about 125° C. The crystallization enthalpy was about 200 J/g. Resin with higher crystallinity has a higher crystallization enthalpy. Therefore, the crystallization behaviours of formulations can be evaluated through the value of crystallization enthalpy.

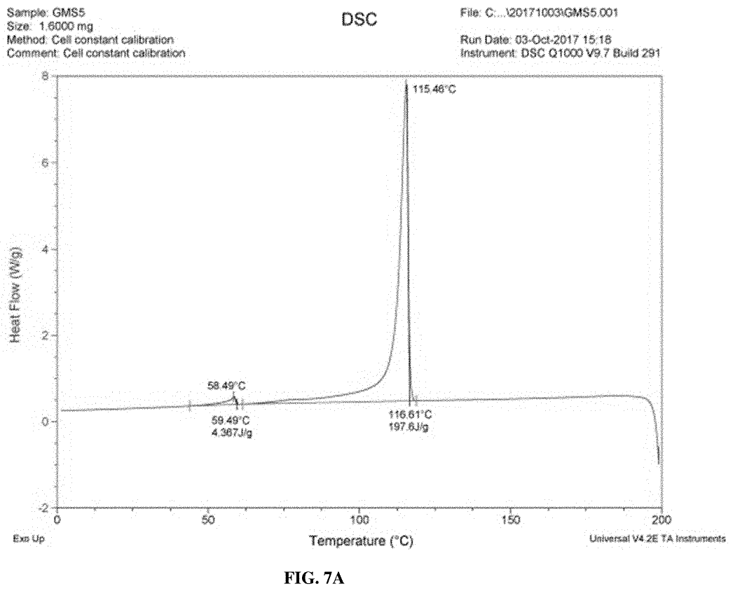

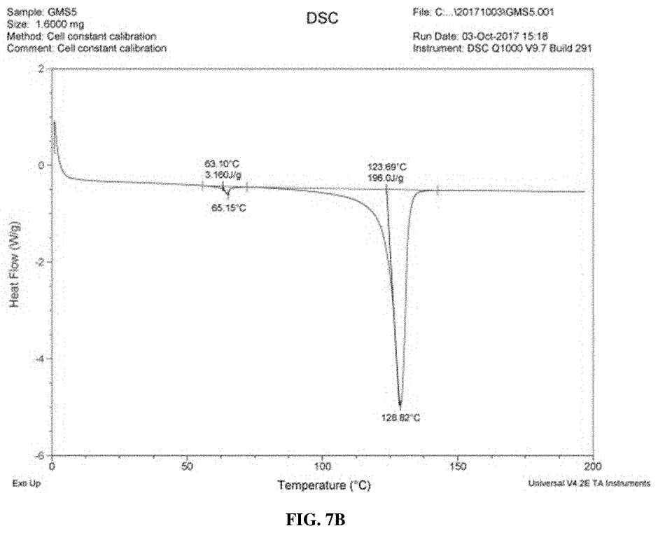

In FIGS. 7A and 7B, two melting points were observed in SHA7260/GMS5: 124° C. for SHA7260 and 63° C. for GMS. The crystallization enthalpy was about 200 J/g, similar to the base resin. This observation revealed that the addition of GMS did not interrupt the crystallization behaviour of base resin. Since a separate melting peak was noted for the crystallization of GMS, it could be deduced that GMS domain should be formed inside the resin and crystallized when the temperature further dropped to 60° C.

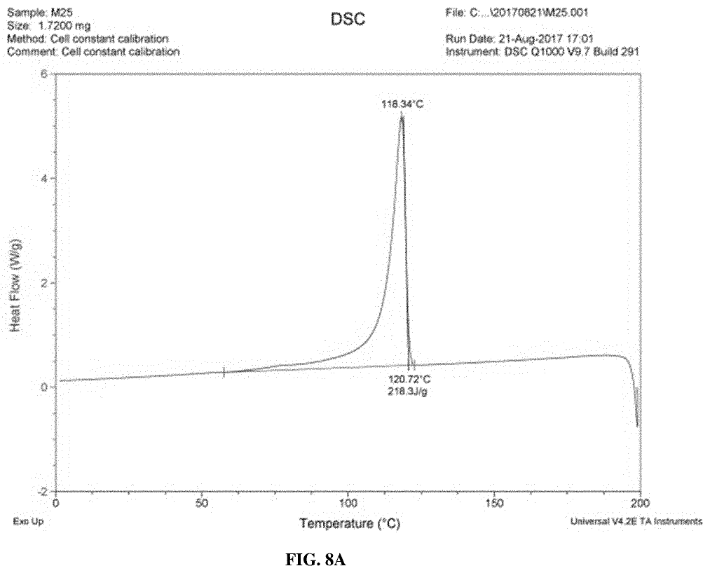

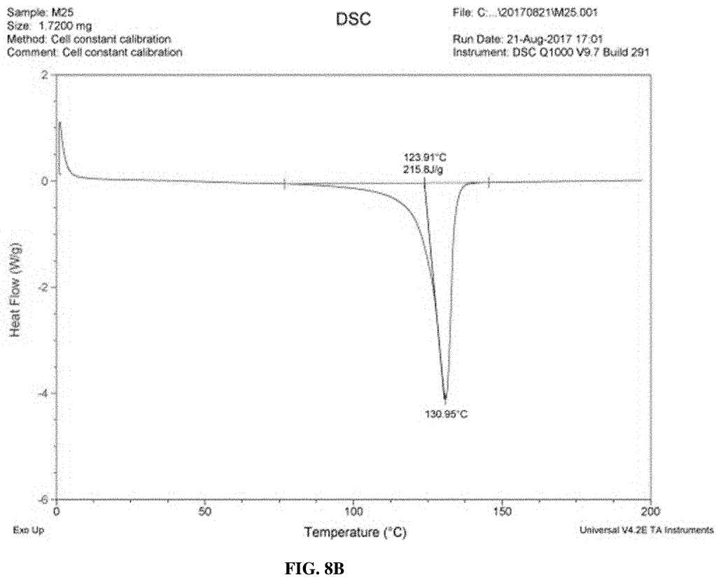

In FIGS. 8A and 8B, the melting point of M25 was about 124° C., which was similar to base resin. Since peaks corresponding to the melting and crystallization of GMS were not observed, it is proposed that GMS was well dispersed in the amorphous phase of the resin. The crystallization enthalpy was about 220 J/g, which was opposite to our expectation. From the experimental result, adding LDPE masterbatch into HDPE slightly increased the resin ‘crystallinity.’ It is proposed the increase of amorphous phase in resin expanded the size of spherulites through increasing the gap between lamellae. As bigger spherulites were formed inside the resin, the crystallization enthalpy increased.

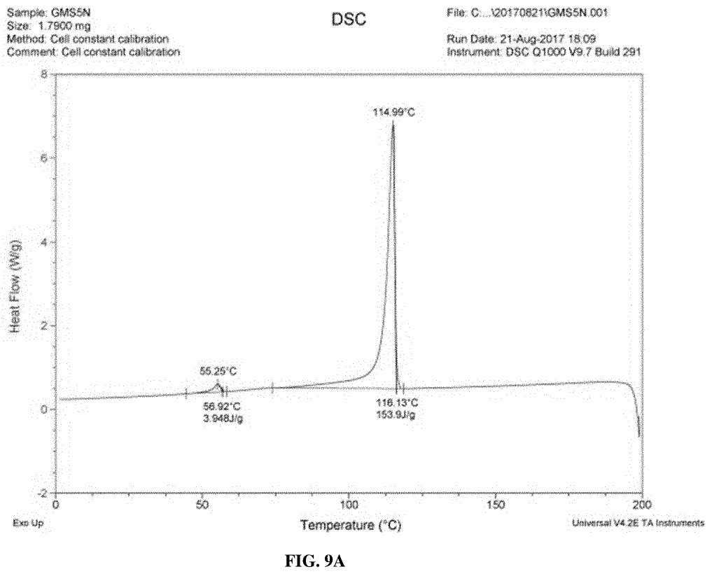

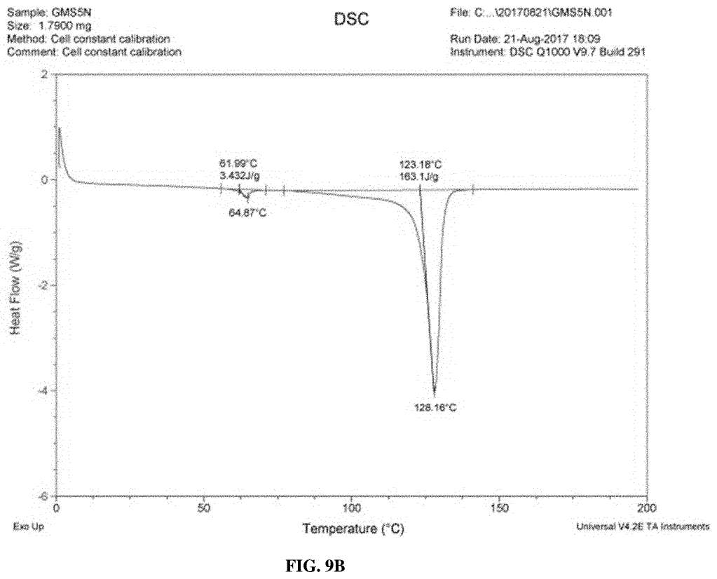

In FIGS. 9A and 9B, two melting points were observed in GMS5N: 123° C. for base resin and 62° C. for GMS. The general features of the DSC scans were similar to that without adding nucleator, but the crystallization enthalpy dramatically decreased to about 150 J/g. This observation indicated the suppression of spherulites formation within resin. Since there was more amorphous region during the crystallization of GMS, the GMS domain could easily migrate to the resin surface to increase the wettability of resin.

(D) Mechanical Properties:

The mechanical properties of GMS2N were evaluated against its base resin SHA7260 according to ISO 527 Type 5B tensile bars were prepared through injection moulding. The tensile properties of GMS1N, GMS2N, GMS5N and SHA7260 were listed in Table 11.

TABLE 11
Mechanical properties of GMS1N, GMS2N, GMS5N
and base resin SHA7260.

| | | | % | | % | | % |
|---|---|---|---|---|---|---|---|
| | SHA7260 | GMS1N | changed | GMS2N | changed | GMS5N | changed |
| Tensile strength | 23.4 | 22.1 | -5% | 21.4 | -9% | 20.9 | -11% |
| at Break (MPa) | | | | | | | |
| Yield strength | 22.2 | 22.5 | 1% | 21.7 | -2% | 21.8 | -2% |
| (MPa) | | | | | | | |
| Tensile strain | 7.6 | 6.6 | -13% | 6.3 | -17% | 7.1 | -6% |
| at Break | | | | | | | |
| (mm/mm) | | | | | | | |
| Yield strain | 0.21 | 0.21 | 0% | 0.23 | 8% | 0.24 | 11% |

Tensile strength and yield strength of GMS1N, GMS2N, and GMS5N showed changes of less than 20% in mechanical properties comparing to its base resin. The decreases in tensile strength and increase in tensile strain were expected as GMS could serve as plasticizer for HDPE. However, the addition of nucleator HPN-20E increased the number of polymer crystals in GMS resin, therefore offset the plasticizer effect to give only a slight change in mechanical properties.

(E) Overall Migration

The migration behaviour GMS2N and GMS5N were evaluated in accordance to two major regulatory standards, EU No. 10/2011 and FDA standard 21 CFR 177.1520. For EU No. 10/2011, there was no detection for overall migration in 3% (w/v) acetic acid and 20% (v/v) ethanol, and hence GMS2N and GMS5N were suitable for common beverage contact in the European market. Both of them also passed the specific migration requirements in EU No. 10/2011 for heavy metal and primary aromatic amines. For 21 CFR 177.1520, total extractable fraction in n-hexane was 1.8% (w/w) and 2.1% (w/w) and that of in xylene was 1.0% (w/w) and 2.8% (w/w) for GMS2N and GMS5N respectively, where all of them were less than the mandated requirements, 5.5% (w/w) and 11.3% (w/w), respectively for the United States market. The migration results indicate both GMS2N and GMS5N could be designated for food contact applications as tested.

(F) Cytotoxicity:

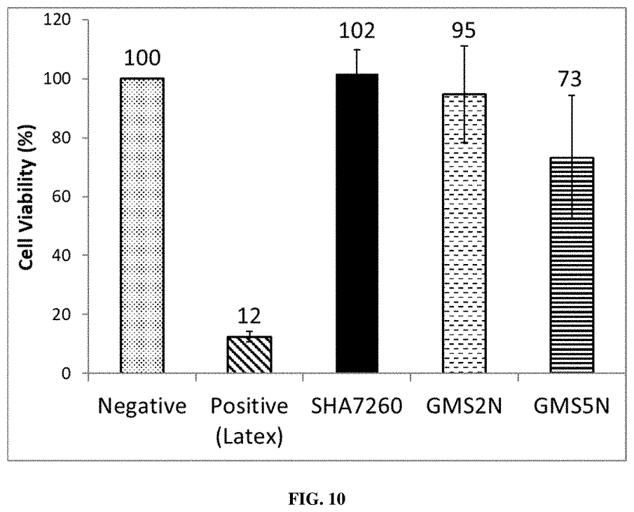

The cytotoxicity of different concentrations of GMS in Bio-PE SHA7260 were evaluated in L929 cell lines in the form of 3-(4,5-dimethyl-thiazol-2-yl)-2,5-dipenyltetrazolium bromide (MTT) assay. Virgin (SHA7260), 1 phr GMS (GMS1N), 2 phr GMS (GMS2N) and 5 phr GMS (GMS5N). As depicted in FIG. 10, the cell viabilities of L929 cell change little with virgin SHA7260 and GMS1N when averaged over six experimental sets. However, the higher the dose of modifier used, the lesser the amount of cells survived. When 2 phr of GMS was added, the cell viability of L929 cells drops to 95%, a decrease of 5% compared with virgin material. It is still considered to be promising for safe usage when the cell viability is above 80%. When 5 phr of GMS is added to SHA7260, the cell viability drops to about 73%. Latex was used as a positive control that shows only 12% of total cells could survive averaged over six experimental sets.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### INDUSTRIAL APPLICABILITY

The present invention is useful in making an article with germ-repelling property suitable for food processing and biomedical device industries as the materials used to impart germ repellence are non-toxic and non-carcinogenic, and may be derived from natural food products, so that the article comprising the present materials is food-safe and ecofriendly.

1. A germ-repellent polymer composition comprising:
a base polymer selected from one or more of polyethylene, polypropylene, poly(lactic acid), polyhydroxylalkanoates, or copolymers or mixtures thereof, wherein at least one candidate of the base polymer is bio-derived polyethylene;
a germ-repelling modifier selected from a glycerol ester, wherein the germ-repelling modifier comprises 5 to 10 weight percent of the germ-repellent polymer composition;
a nucleating agent,
wherein the base polymer is modified by the germ-repelling modifier in order to have an absorption band of hydroxyl bond at about 3300 cm⁻ in an ATR-FTIR spectrum of the modified base polymer surface such that the germ repelling performance of the germ-repellent polymer is over 85%.

2. The germ-repellent polymer composition of claim 1, wherein the base polymer is low-density polyethylene.

3. The germ-repellent polymer composition of claim 1, wherein the base polymer is high-density polyethylene.

4. The germ-repellent polymer composition of claim 1, wherein the glycerol ester is glycerol monostearate (GMS).

5. The germ-repellent polymer composition of claim 1, wherein the glycerol ester is a mixture of stearates of monoglyceride and diglyceride (MDG).

6. The germ-repellent polymer composition of claim 2, wherein the nucleating agent is a calcium ion-based nucleating agent.

7. The germ-repellent polymer composition of claim 3, wherein the nucleating agent is a calcium ion-based nucleating agent.

8. The germ-repellent polymer composition of claim 2, wherein the nucleating agent includes the following compound:

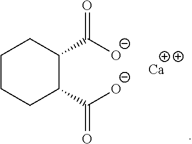 [SMILES: O=C([O-])[C@H]1CCCC[C@H]1C(=O)[O-] ; [Ca+2]]

9. The germ-repellent polymer composition of claim 3, wherein the nucleating agent includes the following compound:

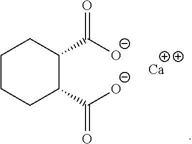 [SMILES: O=C([O-])[C@H]1CCCC[C@H]1C(=O)[O-] ; [Ca+2]]

10. (canceled)

11. The germ-repellent polymer composition of claim 1, wherein the nucleating agent comprises 0.1 to 1.0 phr of the polymer composition.

12. The germ-repellent polymer composition of claim 1, wherein the bio-derived polyethylene is polyethylene made from ingredients which becomes ethylene after dehydration and the ingredients are sourced from natural ingredients including sugars.
